(19) United States
(12) Patent Application Publication
(10) Pub. No.: US 2010/0004354 A1
(43) Pub. Date: Jan. 7, 2010

(54) ALKOXYSILYL FUNCTIONAL OLIGOMERS AND PARTICLES SURFACE-MODIFIED THEREWITH

(75) Inventors: Christoph Briehn, Zeilarn (DE); Sabine Delica, Munich (DE); Oliver Minge, Munich (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/305,117

(22) PCT Filed: Jun. 20, 2007
(86) PCT No.: PCT/EP2007/056146

§ 371 Date: Dec. 16, 2008

(30) Foreign Application Priority Data
Jun. 27, 2006 (DE) 10 2006 029 429.7

(51) Int. Cl. C08K 9/06; C08L 83/06

(52) U.S. Cl. 523/212; 525/55

(57) ABSTRACT

Oligomers are prepared by polymerizing unsaturated silanes, optionally along with a copolymerizable ethylenically unsaturated monomer. The oligomers are particularly useful for preparing core-shell particles.

The invention relates to alkoxysilyl-functional oligomers, to core-shell particles (PA) which carry oligomer (A) on their surface, and to use of the particles (PA) for producing composite materials (K).

A filler is a finely divided solid which as a result of its addition to a matrix alters the properties of said matrix. Fillers are presently used in the chemical industry for numerous purposes. They may alter the mechanical properties of plastics, such as hardness, tensile strength, chemical resistance, electrical or thermal conductivities, adhesion or else contraction on temperature change, for example. Furthermore, they have the effect, among others, of influencing the rheological behavior of polymeric melts, and improve the scratch resistance of coatings.

A problem which occurs frequently when the particles—which are generally inorganic particles—and especially the nanoparticles are used in organic systems is a commonly inadequate compatibility between particle and matrix. A possible result of this lack of compatibility is that the particles cannot be dispersed well enough in the organic matrix. Moreover, on prolonged periods of standing or storage, even particles that have been well dispersed may settle, forming possibly relatively large aggregates and/or agglomerates, which on redispersion are difficult, if not impossible, to separate into the original particles. The processing of inhomogeneous systems of this kind is extremely difficult in any case, and is often in fact impossible. Thus, for example, coatings which, after they have been applied and cured, possess smooth surfaces cannot generally be produced by this route, or only by costly methods.

Favorable, therefore, is the use of particles which on their surface possess organic groups that lead to improved compatibility with the surrounding matrix. In this way the inorganic particle is masked by an organic shell. Where the particle surface, moreover, possesses suitable reactivity toward the matrix, and so is able to react with the binder system under the particular curing conditions of the formulation, it is possible to incorporate the particles into the matrix chemically in the course of curing, and this often results in particularly good mechanical properties, but also in an improved chemical resistance. Preference is given in this context, for example, to amine groups or carbinol groups, which are able to react, for example, with polyesters, polyurethanes or polyacrylates. Systems of this kind are described in EP 832 947 A, for example.

For surface modification the prior art prefers to use hydrolysable silanes such as, for example, γ-glycidyloxypropyltrimethoxysilane, γ-aminopropyltrimethoxysilane and γ-methacrylatopropyltrimethoxysilane, which are reactive with respect to the particle surface and which, on reaction with the particle, form a siloxane shell that masks the particle core. Production processes of this kind are described in EP 505 737 A, for example. On account of the organofunctional radicals, the compatibility of these particles with an organic matrix is very good. A problem experienced with these systems, however, may be, when silanes with low hydrolysis and condensation reactivity are employed, that the siloxane shell which is formed still possesses a large number of alkoxysilyl and silanol groups. The stability of these particles under the conditions of preparation—especially under the conditions of a solvent exchange—and of storage, therefore, is limited. Despite the masking siloxane shell, agglomeration and/or aggregation of the particles may occur. For the reasons stated, it is also generally not possible to isolate the particles in solid form and then redisperse them in a solvent or in the composite matrix. Redispersibility of this kind for the particles would be especially desirable, since it would make it substantially easier to produce the composite materials.

The preparation of core-shell particles which on their surface are free from alkoxysilyl and silanol groups and which, accordingly, have a relatively low tendency toward agglomeration is taught by documents EP 0 492 376 A and DE 10 2004 022 406 A. For this purpose, in a first step, a siloxane particle is generated by cocondensation of different silanes and siloxanes, at least one silane or siloxane carrying methacrylic groups, and, in the subsequent step, a polymethyl methacrylate shell is grafted onto said siloxane particle by reaction with methyl methacrylate. The particles obtained exhibit outstanding compatibilities in organic polymers such as polymethyl methacrylate and PVC, for example. These siloxane graft polymers have the advantage, moreover, that given a suitable composition and suitable thickness of the grafted shell, they are redispersible. However, they possess the disadvantage of being relatively complicated to prepare, leading to high preparation costs.

The object on which the present invention is based, then, is that of providing a surface modifier which permits the production of core-shell particles and, furthermore, overcomes the disadvantages corresponding to the prior art.

The invention provides alkoxysilyl-functional oligomers (A) and their hydrolysis and condensation products, obtainable by polymerizing 100 parts by weight of ethylenically unsaturated alkoxy-functional silane (S) together with 0 to 100 parts by weight of ethylenically unsaturated comonomers (C).

An “oligomer” in this context is a relatively high molecular mass molecule composed of at least 2 (degree of polymerization: 2), but not more than 100 (degree of polymerization: 100) monomeric units. Preference is given in this context to degrees of polymerization of 2 to 50; particular preference is given to degrees of polymerization of 2 to 20. The degree of polymerization is calculated, for example, from the number-average molar mass Mn, determined by way of GPC or NMR, divided by the molarly weighted average of all the molar masses of the monomers used. The sequence of the silane building blocks (S) and, where appropriate, of the comonomers (C) in the oligomer (A) may, depending on the type of polymerization, be random, blocklike, alternating or gradientlike. Particular preference is given to random and blocklike sequences.

Suitability as silane (S) is possessed by all silanes, and their hydrolysis and condensation products, which carry ethylenically unsaturated bonds that are amenable to a polymerization, more particularly to free-radical polymerization. Examples of such polymerizable silanes include vinylsilanes such as vinyltrimethoxysilane, vinyltriethoxysilane or vinyltriacetoxysilane, and also acrylosilanes and methacrylosilanes, examples being the GENIOSIL® GF-31, XL-33, XL-32, XL-34, and XL-36 silanes that are sold by Wacker Chemie AG, Munich, Germany. Particularly preferred silanes (S) are those of the general formula [1]

R¹ₙ(R¹¹O)₃₋ₙSi-L-O—CO—CR²¹═CH₂ [1]

where
R¹, R¹¹, and R²¹ are C₁-C₈ alkyl radicals and
n denotes values 0, 1 or 2, and
L denotes a C₁-C₈ alkylene radical.

The radicals R¹, R¹¹, and R²¹ may be linear, branched or cyclic. Preferably R¹¹ and R²¹ are methyl, ethyl, n-propyl or isopropyl radicals. More particularly R¹, R¹¹, and R²¹ are methyl. In particular, n is 0. Preferably L is a methylene or propylene radical. Further preferred silanes (S) are the compounds methacryloyloxypropyltrimethoxysilane, acrylamido-propyltrimethoxysilane, methacrylamidopropyltrimethoxysilane, acrylamidomethyltrimethoxysilane, methacrylamidomethyltrimethoxysilane. Also suitable are the corresponding di- and monoalkoxysilanes of the stated ethylenically unsaturated silanes (S). Preferably at least 10 mol %, more preferably at least 30 mol %, more particularly at least 50 mol % of the silanes (S) and their hydrolysis and condensation products have alkoxy groups.

Suitable comonomers (C) are compounds from the group encompassing vinyl esters, (meth)acrylic esters, vinylaromatics, olefins, 1,3-dienes, vinyl ethers, and vinyl halides. Particularly suitable vinyl esters are those of carboxylic acids having 1 to 15 C atoms. Preference is given to vinyl acetate, vinyl propionate, vinyl butyrate, vinyl 2-ethylhexanoate, vinyl laurate, 1-methylvinyl acetate, vinyl pivalate, and vinyl esters of α-branched monocarboxylic acids having 9 to 11 C atoms, an example being VeoVa9® or VeoVa10® (trade names of Resolution). Particular preference is given to vinyl acetate.

Suitable monomers from the group of acrylic esters or methacrylic esters are, for example, esters of unbranched or branched alcohols having 1 to 15 C atoms. Preferred methacrylic esters or acrylic esters are methyl acrylate, methyl methacrylate, ethyl acrylate, ethyl methacrylate, propyl acrylate, propyl methacrylate, n-butyl acrylate, n-butyl methacrylate, isobutyl acrylate, isobutyl methacrylate, t-butyl acrylate, t-butyl methacrylate, 2-ethylhexyl acrylate, and norbornyl acrylate. Particular preference is given to methyl acrylate, methyl methacrylate, n-butyl acrylate, isobutyl acrylate, t-butyl acrylate, 2-ethyl-hexyl acrylate, and norbornyl acrylate.

Preferred vinylaromatics are styrene, alpha-methyl-styrene, the isomeric vinyltoluenes and vinylxylenes, and also divinylbenzenes. Styrene is particularly preferred. Among the vinyl halogen compounds, mention may be made of vinyl chloride, vinylidene chloride, and also tetrafluoroethylene, difluoroethylene, hexylperfluoroethylene, 3,3,3-trifluoropropene, perfluoropropyl vinyl ether, hexafluoropropylene, chlorotrifluoroethylene, and vinyl fluoride. Vinyl chloride is particularly preferred.

An example of a preferred vinyl ether is methyl vinyl ether.

The preferred olefins are ethene, propene, 1-alkylethenes, and polyunsaturated alkenes, and the preferred dienes are 1,3-butadiene and isoprene. Particularly preferred are ethene and 1,3-butadiene. Further comonomers (C) are ethylenically unsaturated mono-carboxylic and dicarboxylic acids, preferably acrylic acid, methacrylic acid, fumaric acid, and maleic acid; ethylenically unsaturated carboxamides and carbonitriles, preferably acrylamide and acrylonitrile; monoesters and diesters of fumaric acid and maleic acid such as the diethyl and diisopropyl esters and also maleic anhydride, ethylenically unsaturated sulfonic acids and/or their salts, preferably vinylsulfonic acid, 2-acrylamido-2-methylpropanesulfonic acid. Further examples are precrosslinking comonomers such as polyethylenically unsaturated comonomers, examples being divinyl adipate, diallyl maleate, allyl methacrylate or triallyl cyanurate, or postcrosslinking comonomers, examples being acrylamidoglycolic acid (AGA), methylacrylamidoglycolic acid methyl ester (MAGME), N-methylolacrylamide (NMA), N-methylolmethacrylamide, N-methylolallylcarbamate, alkyl ethers such as the isobutoxy ether or esters of N-methylol-acrylamide, of N-methylolmethacrylamide, and of N-methylolallylcarbamate. Also suitable are epoxide-functional comonomers such as glycidyl methacrylate and glycidyl acrylate. Mention may also be made of monomers with hydroxyl groups or CO groups, examples being hydroxyalkyl esters of methacrylic acid and acrylic acid such as hydroxyethyl, hydroxypropyl or hydroxyl-butyl acrylate or methacrylate, and also compounds such as diacetoneacrylamide and acetylacetoxyethyl acrylate or methacrylate.

Particular preference is given as comonomers (C) to one or more monomers from the group consisting of vinyl acetate, vinyl esters of α-branched monocarboxylic acids having 9 to 11 C atoms, vinyl chloride, ethylene, methyl acrylate, methyl methacrylate, ethyl acrylate, ethyl methacrylate, propyl acrylate, propyl methacrylate, n-butyl acrylate, n-butyl methacrylate, 2-ethylhexyl acrylate, styrene, 1,3-butadiene.

Also particularly preferred are comonomers (C) which introduce organic functionalities into the polymer backbone, examples being glycidyl (meth)acrylates, hydroxyalkyl (meth)acrylates, aminoalkyl (meth)acrylates, and N-methylolacrylamide.

As the polymerization methodology employed for preparing the oligomers (A), preference is given to employing free-radical methods and also ionic methods in their various forms:

Hence the preparation may take place in bulk or in a suitable solvent via free, radical polymerization. In this case the polymerization is initiated by means of the initiators or redox-initiator combinations, or mixtures of these, that are typical in polymer chemistry. Factors critical to the choice of suitable initiator here include its solubility in the solvent/monomer mixture used, this solubility necessarily being other than zero. An overview of suitable initiators is found in the “Handbook of Free Radical Initiators”, E. T. Denisov, T. G. Denisova, T. S. Pokidova, 2003, Wiley. Examples of initiators are the sodium, potassium, and ammonium salts of peroxodisulfuric acid, hydrogen peroxide, t-butyl peroxide, t-butyl hydroperoxide, potassium peroxodiphosphate, t-butyl peroxopivalate, cumene hydroperoxide, iso-propylbenzene monohydroperoxide, dibenzoyl peroxide or azobisisobutyronitrile. The stated initiators are used preferably in amounts of 0.01% to 4.0% by weight, based on the total weight of the monomers.

As redox-initiator combinations, aforementioned initiators are used in conjunction with a reducing agent. Suitable reducing agents are sulfites and bisulfites of monovalent cations, an example being sodium sulfite, the derivatives of sulfoxylic acid such as zinc or alkali metal formaldehyde-sulfoxylates, an example being sodium hydroxymethanesulfinate, and ascorbic acid. The amount of reducing agent is preferably 0.15% to 3% by weight of the amount of monomer employed. Additionally it is possible to introduce small amounts of a metal compound which is soluble in the polymerization medium and whose metal component is redox-active under the polymerization conditions, being based, for example, on iron or vanadium.

Alternatively the free-radical polymerization may also take place in a controlled way, by means for example of the methods of ATRP (atom transfer radical polymerization), of NMP (nitroxide mediated polymerization) or of RAFT (rapid addition fragmentation transfer) polymerization. In the case of ATRP polymerization, it is appropriate to work in the presence of a Cu(I)-nitrogen complex which is known to serve as a catalyst. Use may also be made, however, of other transition metal complex catalysts. An overview of possible transition metal complexes is offered by K. Matyjaszewski, J. Xia, Chem. Rev. 2001, 101, 2921-2990. A complex consisting of a Cu(I) center and 2,2′-bipyridine is preferred. This complex may have been formed beforehand or may only come about in situ, such as, for instance, from Cu(0) or Cu(II) precursor compounds, which form the catalytically active species as a result of processes of oxidation and reduction. Suitable initiators include α-halogen carboxylic acid derivatives such as esters, amides or thioesters. Likewise suitable are compounds containing α-halogenated fluorene units. Also conceivable are polyhalogenated compounds such as chloroform, HCCl₃, or carbon tetrachloride, CCl₄. Sulfonyl halides and halogen imides are likewise conceivable initiators. Most preferred, however, are α-halogen carboxylic acid derivatives, e.g., ethyl 2-chloro/bromopropionate or ethyl 2-chloro/bromoisobutyrate. A preferred solvent is toluene.

In the case of the NMP reaction, a particularly preferred reversible terminating reagent is TEMPO (2,2,6,6-tetramethylpiperidine 1-oxyl) and its derivatives. Particular preference is given to 4-hydroxy-TEMPO, 4-acetamido-TEMPO, and to polymer-bound TEMPO, bound for instance on silica or polystyrene. Preference in this case is also given to polymerization in the presence of <1% by weight of acetic anhydride or acetic acid. All of the free-radical initiators already discussed are suitable initiators. The reaction takes place preferably in organic solution and at temperatures >100° C. A preferred solvent is the solvent in which the oligomer is subsequently employed.

In the case of RAFT polymerization, particularly preferred reversible terminating reagents are xanthogenates and dithiocarbamidates, particular preference being given to O-alkylxanthan acids and their salts. Very particular preference is given to the sodium salt of O-ethylxanthan acid. Suitable initiators are all of the free-radical initiators already discussed. The reaction takes place preferably in organic solution and at temperatures <100° C. A preferred solvent is the solvent in which the oligomer is subsequently employed.

The polymerization takes place preferably in the form of a free or controlled free-radical or ionic polymerization. Preference is given to polymerization via ATRP methods and also by free-radical polymerization. The polymerization is preferably carried out in a solvent. A preferred solvent is the solvent in which the oligomer is subsequently employed.

The polymerization may alternatively take place by means of ionic methods, such as a cationic or anionic polymerization, for example.

The polymerization may be carried out batchwise, semibatchwise or continuously, with the initial introduction of all or individual constituents of the reaction mixture, with some of the constituents of the reaction mixture being included in the initial charge and some being metered in subsequently, or by the metering method without an initial charge. All metered additions take place preferably at the rate at which the respective component is consumed. In the case of a controlled polymerization, the polymerization takes place preferably in batch mode, unless block structures are being realized, in which case a semibatch mode is preferred. In the case of free-radical polymerization, a semibatch mode is preferred.

Further provided by the invention are core-shell particles (PA) which on their surface carry the oligomer (A) or its hydrolysis and condensation products.

The particles (PA) of the invention preferably possess a specific surface area of 0.1 to 1000 m²/g, more preferably of 10 to 500 m²/g (measured by the BET method in accordance with DIN EN ISO 9277/DIN 66132). The average size of the primary particles is preferably less than 10 μm, more preferably less than 1000 nm, the primary particles being able to be present as aggregates (as defined in DIN 53206) and agglomerates (as defined in DIN 53206), which as a function of the external shearing load (imposed, for example, by the measuring conditions) may have sizes of 1 to 1000 μm.

In the core-shell particle (PA) the oligomers (A) may be attached covalently, via ionic interactions or via van-der-Waals interactions to the particle surface. The oligomers (A) are preferably attached covalently.

The oligomers (A) are outstandingly suitable for functionalizing particles (P). The resultant particles (PA) are redispersible in common organic solvents and are outstandingly compatible with a variety of matrix systems.

The oligomers (A) can be prepared comparatively cost-effectively from the corresponding unsaturated silanes (S). Moreover, the preparation of the redispersible and compatible particles (PA) from particles (P) and the oligomers (A), which can usually be carried out simply by simple mixing of the two components, is very simple. Accordingly the oligomers (A) of the invention and the particles (PA) that are obtainable from them represent a great advantage over the prior art.

The invention further provides a process for producing the particles (PA), wherein particles (P) are reacted with the oligomers (A).

A preferred process for producing the particles (PA) is that particles (P) which have functions selected from metal-OH, metal-O-metal, Si—OH, Si—O—Si, Si—O-metal, Si—X, metal-X, metal-OR², Si—OR² are reacted with oligomers (A) or their hydrolysis, alcoholysis, and condensation products,

where
R² is a substituted or unsubstituted alkyl radical and
X is a halogen atom.

R² is preferably an alkyl radical having 1 to 10, more particularly 1 to 6, carbon atoms. Particular preference is given to the radicals methyl, ethyl, n-propyl, isopropyl. X is preferably chlorine.

Where the particles (PA) are produced using particles (P) which have functions selected from metal-OH, Si—OH, Si—X, metal-X, metal-OR², Si—OR², the attachment of the oligomers (A) takes place preferably by hydrolysis and/or condensation. Where exclusively metal-O-metal, metal-O—Si or Si—O—Si functions are present in the particle (P), the covalent attachment of the oligomers (A) may take place by means of an equilibration reaction. The procedure and also the catalysts needed for the equilibration reaction are familiar to the skilled worker and are described numerously in the literature.

Suitable particles (P), on grounds of ease of technical handling, are oxides with a covalent bonding component in the metal-oxygen bond, preferably oxides of main group 3, such as boron, aluminum, gallium or indium oxides, of main group 4, such as silicon oxide, germanium dioxide, tin oxide, tin dioxide, lead oxide, lead dioxide, or oxides of transition group 4, such as titanium oxide, zirconium oxide and hafnium oxide. Further examples are oxides of nickel, of cobalt, of iron, of manganese, of chromium, and of vanadium. Suitability is possessed, moreover, by metals having an oxidized surface, zeolites (a listing of suitable zeolites is found in: Atlas of Zeolite Framework Types, 5^{th} edition, Ch. Baerlocher, W. M. Meier, D. H. Olson, Amsterdam: Elsevier 2001), silicates, aluminates, aluminophosphates, titanates, and aluminum phyllosilicates (e.g., bentonites, montmorillonites, smectites, hectorites), the particles (P) preferably having a specific surface area of 0.1 to 1000 m²/g, more preferably of 10 to 500 m²/g (measured by the BET method in accordance with DIN 66131 and 66132). The particles (P), which preferably have an average diameter of less than 10 μm, more preferably less than 1000 nm, may take the form of aggregates (as defined in DIN 53206) and agglomerates (as defined in DIN 53206), which as a function of the external shearing load (imposed by the measuring conditions, for example) may have sizes of 1 to 1000 μm.

A particularly preferred particle (P) is fumed silica, prepared in a flame reaction from organosilicon compounds, such as from silicon tetrachloride or methyldichlorosilane, for example, or from hydrotrichlorosilane or hydromethyldichlorosilane, or from other methylchlorosilanes or alkylchlorosilanes, alone or in a mixture with hydrocarbons, or from any desired volatilizable or sprayable mixtures of organosilicon compounds, as stated, and hydrocarbons, in an oxygen-hydrogen flame, for example, or else in a carbon monoxide-oxygen flame. The silica may be prepared optionally with or without addition of water, in the purification step, for example; preferably no water is added.

Fumed, or pyrogenically prepared, silica or silicon dioxide is known, for example, from Ullmann's Enzyklopädie der Technischen Chemie 4^{th} edition, Volume 21, page 464. The unmodified fumed silica has a specific BET surface area, measured in accordance with DIN EN ISO 9277/DIN 66132, of 10 m²/g to 600 m²/g, preferably of 50 m²/g to 400 m²/g . The unmodified fumed silica preferably has a tapped density, measured in accordance with DIN EN ISO 787-11, of 10 g/l to 500 g/l, preferably of 20 g/l to 200 g/l, and more preferably of 30 g/l to 100 g/l.

The pyrogenic silica preferably has a fractal surface dimension of preferably less than or equal to 2.3, more preferably of less than or equal to 2.1, with particular preference of 1.95 to 2.05, the fractal surface dimension Dₛ, being defined here as follows: Particle surface area A is proportional to particle radius R to the power of Dₛ.

In a further preferred embodiment of the invention, colloidal silicon oxides or metal oxides are used as particles (P), these oxides generally taking the form of a dispersion of the corresponding oxide particles of submicron size in an aqueous or organic solvent. Oxides which can be used in this context include the oxides of the metals aluminum, titanium, zirconium, tantalum, tungsten, hafnium, and tin, or the corresponding mixed oxides. Particular preference is given to silica sols. Examples of commercially available silica sols suitable for producing the particles (PA) are silica sols of the product series Ludox® (Grace Davison), Snowtex® (Nissan Chemical), Klebosol® (Clariant), and Levasil® (H. C. Starck), silica sols in organic solvents such as, for example, IPA-ST (Nissan Chemical), or silica sols of the kind preparable by the Stöber process.

A further preferred embodiment of the invention uses, as particles (P), organopolysiloxanes of the general formula [2]

[R³₃SiO_{1/2}]ᵢ[R³₂SiO_{2/2}]ⱼ[R³SiO_{3/2}]ₖ[SiO_{4/2}]ₗ [2]

where
R³ is an OH function, an optionally halogen-, hydroxyl-, amino-, epoxy-, phosphonato-, thiol-, (meth)acryloyl-, carbamate- or else NCO-substituted hydrocarbon radical having 1-18 carbon atoms, it being possible for the carbon chain to be interrupted by nonadjacent oxygen, sulfur or amine groups, and
i, j, k, and l denote a value greater than or equal to 0,
   with the proviso that i+j+k+l is greater than or equal to 3, more particularly at least 10.

The particles (PA) of the invention are produced by reacting the particles (P) with the oligomers (A) preferably at 0° C. to 150° C., more preferably at 20° C. to 80° C. The process can be carried out either with employment of solvents, or solvent-free. Where solvents are used, protic and aprotic solvents and mixtures of different protic and aprotic solvents are suitable. It is preferred to employ protic solvents, such as water, methanol, ethanol, isopropanol, or polar aprotic solvents, such as THF, DMF, NMP, diethyl ether or methyl ethyl ketone, for example. Likewise preferred are solvents or solvent mixtures having a boiling point or boiling range, respectively, of up to 120° C. at 0.1 MPa. Very particular preference is given to the use of an isopropanol/toluene mixture.

The oligomers (A) used to modify the particles (P) are used preferably in amount greater than 1% by weight (based on the particles (P)), more preferably greater than 5% by weight, with particular preference greater than 8% by weight.

In the reaction of the particles (P) with the oligomers (A) it is possible to operate under vacuum, under superatmospheric pressure or at atmospheric pressure (0.1 MPa). The elimination products that may be formed in the course of the reaction, such as alcohols, for example, may either remain in the product and/or be removed from the reaction mixture by application of vacuum and/or raising of the temperature.

In the reaction of the particles (P) with the oligomers (A) it is possible to add catalysts.

In this context it is possible to use all catalysts that are typically used for this purpose, such as organotin compounds, examples being dibutyltin dilaurate, dioctyltin dilaurate, dibutyltin diacetyl-acetonate, dibutyltin diacetate or dibutyltin dioctoate, etc., organic titanates, titanium(IV) isopropoxide, for example, iron(III) compounds, iron(III) acetylacetonate, for example, or else amines, examples being triethylamine, tributylamine, 1,4-diazabicyclo[2.2.2]octane, 1,8-diazabicyclo[5.4.0]-undec-7-ene, 1,5-diazabicyclo[4.3.0]non-5-ene, N,N-bis(N,N-dimethyl-2-aminoethyl)methylamine, N,N-di-methylcyclohexylamine, N,N-dimethylphenylamine, N-ethylmorpholine, etc. Organic or inorganic Brönsted acids as well are suitable, such as acetic acid, tri-fluoroacetic acid, hydrochloric acid, phosphoric acid and the monoesters and/or diesters thereof, such as butyl phosphate, isopropyl phosphate, dibutyl phosphate, etc., for example, and acid chlorides such as benzoyl chloride, as catalysts. The catalysts are used preferably in concentrations of 0.01-10% by weight. The various catalysts may be used both in pure form and as mixtures of different catalysts.

Following the reaction of the particles (P) with the oligomers (A), the catalysts used are preferably deactivated by addition of what are called anticatalysts or catalyst poisons, before they can lead to cleavage of the Si—O—Si groups. This secondary reaction is dependent on the catalyst used and need not necessarily occur, and so where appropriate it is also possible to omit the deactivation. Examples of catalyst poisons are acids, for example, when using bases and bases, for example, when using acid, these acids and bases neutralizing the bases and acids employed, respectively. The products formed by the neutralization reaction can if appropriate be separated off by filtration or extracted. The reaction products preferably remain in the product.

Where appropriate, the addition of water is preferred for the reaction of the particles (P) with the oligomers (A).

In the case of the production of the particles (PA) from particles (P) it is possible, as well as the oligomers (A), to use silanes (S1), silazanes (S2), siloxanes (S3) or other compounds (L). Preferably the silanes (S1), silazanes (S2), siloxanes (S3) or other compounds (L) are reactive toward the functions of the surface of the particle (P). The silanes (S1) and siloxanes (S3) possess either silanol groups or hydrolysable silyl functions, the latter being preferred. The silanes (S1), silazanes (S2), and siloxanes (S3) may possess organic functions, but alternatively it is possible to use silanes (S1), silazanes (S2), and siloxanes (S3) without organic functions. The oligomers (A) may be used as a mixture with the silanes (S1), silazanes (S2) or siloxanes (S3). In addition, the particles may also be functionalized in succession with the oligomers (A) and with the different types of silane. Examples of suitable compounds (L) are metal alkoxides, such as titanium(IV) isopropoxide or aluminum(III) butoxide, for example, protective colloids, such as polyvinyl alcohols, cellulose derivatives or vinylpyrrolidone polymers, for example, and also emulsifiers such as, for example, ethoxylated alcohols and phenols (alkyl radical C₄-C₁₈, EO degree 3-100), alkali metal salts and ammonium salts of alkyl sulfates (C₃-C₁₈), sulfuric and phosphoric esters, and alkylsulfonates. Particular preference is given to sulfosuccinic esters and also alkali metal alkyl sulfates and also polyvinyl alcohols. It is also possible to use two or more protective colloids and/or emulsifiers in the form of a mixture.

Particular preference is given in this context to mixtures of oligomers (A) with silanes (S1) of the general formula [3]

(R⁴O)_{4-a-b}(Z)ₛSi(R¹⁴)_{b} [3]

where
Z denotes halogen atom, pseudohalogen radical, Si—N-bonded amine radical, amide radical, oxime radical, amineoxy radical or acyloxy radical,
a is 0, 1, 2 or 3,
b is 0, 1, 2 or 3,
R⁴ has the definitions of R¹¹ and R¹⁴ has the definitions of R³, and a+b is less than or equal to 4.

Here, a is preferably 0, 1 or 2, while b is preferably 0 or 1. R⁴ preferably has the definitions of R¹¹.

Silazanes (S2) and siloxanes (S3) used with particular preference are hexamethyldisilazane and hexamethyldisiloxane or linear siloxanes having organofunctional chain ends.

The silanes (S1), silazanes (S2), siloxanes (S3) or other compounds (L) used for modifying the particles (P) are used preferably in an amount of >1% by weight (based on the particles (P)).

The modified particles (PA) obtained from the particles (P) may be isolated by common methods such as, for example, by evaporation of the solvents used or by spray drying, to give a powder. Alternatively it is possible not to isolate the particles (PA).

Additionally, in one preferred procedure following the production of the particles (PA), it is possible to use methods of deagglomerating the particles, such as pinned-disk mills or apparatus for milling and classifying, such as pinned-disk mills, hammer mills, opposed-jet mills, bead mills, ball mills, impact mills or milling/classifying apparatus.

The invention additionally provides a process for producing the particles (PA), wherein the attachment of the oligomers (A) takes place during the synthesis of the particles (P). According to this process, the particles (P) can be prepared preferably by cohydrolysis of oligomers (A) with alkoxysilanes (S1) of the general formula [3], silazanes (S2) or siloxanes (S3).

The invention further provides for the use of the particles (PA) of the invention to produce composite materials (K).

Matrix materials (M) employed for producing the composite materials (K) include both organic and inorganic polymers. Examples of polymer matrices (M) of this kind are polyethylenes, polypropylenes, polyamides, polyimides, polycarbonates, polyesters, polyetherimides, polyethersulfones, polyphenylene oxides, polyphenylene sulfides, polysulfones (PSU), polyphenylsulfones (PPSU), polyurethanes, polyvinyl chlorides, polytetrafluoroethylenes (PTFE), polystyrenes (PS), polyvinyl alcohols (PVA), polyether glycols (PEG), polyphenylene oxides (PPO), polyaryletherketones, epoxy resins, polyacrylates, poly-methacrylates, and silicone resins.

Polymers likewise suitable as matrix (M) are oxidic materials which are obtainable by common sol-gel methods known to the skilled person. In accordance with the sol-gel method, hydrolysable and condensable silanes and/or organometallic reagents are hydrolysed by means of water and optionally in the presence of a catalyst and are cured by suitable methods to form the silicatic or oxidic materials.

Where the silanes or organometallic reagents carry organofunctional groups (such as epoxy, methacryloyl, amine groups, for example) which may be employed for crosslinking, these modified sol-gel materials may additionally be cured via their organic component. The curing of the organic component may in this case take place—where appropriate after addition of further reactive organic components—thermally or by UV radiation, among other means. Suitability as matrix (M) is thus possessed, for example, by sol-gel materials which are obtainable by reaction of an epoxy-functional alkoxysilane with an epoxy resin and optionally in the presence of an amine curing agent. A further example of organic-inorganic polymers of this kind are sol-gel materials (M) which can be prepared from amino-functional alkoxysilanes and epoxy resins. Through the introduction of the organic component it is possible, for example, to enhance the elasticity of a sol-gel film. Organic-inorganic polymers of this kind are described in Thin Solid Films 1999, 351, 198-203, for example.

Further suitable matrix materials (M) include mixtures of different matrix polymers and/or the corresponding copolymers.

It is also possible, moreover, to use reactive resins as matrix material (M). By reactive resins in this context are meant compounds which possess one or more reactive groups. Reactive groups that may be mentioned here, by way of example, include hydroxyl, amino, isocyanate, epoxide groups, ethylenically unsaturated groups, and also moisture-crosslinking alkoxysilyl groups. In the presence of a suitable initiator and/or curing agent, the reactive resins may be polymerized by thermal treatment or actinic radiation.

These reactive resins may be in monomeric, oligomeric, and polymeric form. Examples of common reactive resins are as follows: hydroxy-functional resins such as, for example, hydroxyl-containing polyacrylates or polyesters, which are crosslinked with isocyanate-functional curing agents; acryloyl- and methacryloyl-functional resins, which following addition of an initiator are cured thermally or by actinic radiation; epoxy resins, which are crosslinked with amine curatives; vinyl-functional siloxanes, which can be crosslinked by reaction with an SiH-functional curative; and SiOH-functional siloxanes, which can be cured by a polycondensation.

In the composite material (K) the particles (PS) of the invention may have a distribution gradient or may be homogeneously distributed. Depending on the matrix system selected, either a homogeneous distribution or else an uneven distribution of the particles may, for example, be advantageous in respect of the mechanical stability or the chemical resistance.

Where the particles (PA) of the invention carry organo-functional groups which are reactive toward the matrix (M), then the particles (PA), following their dispersion, may be attached covalently to the matrix (M).

The amount of the particles (PA) present in the composite material (K), based on the total weight, is preferably at least 1% by weight, preferably at least 5% by weight, more preferably at least 10%, and preferably not more than 90% by weight. These composite materials (K) may comprise one or more different types of particles (PA). Thus, for example, the invention provides composites (K) which comprise modified silicon dioxide and also modified aluminum oxide.

The composite materials (K) are produced preferably in a two-stage process. In a first stage, dispersions (D) are prepared by incorporation of the particles (PA) into the matrix material (M). In a second step, the dispersions (D) are converted into the composite materials (K).

For the preparation of the dispersions (D), the matrix material (M) and also the particles (PA) of the invention are dissolved or dispersed in a solvent, preferably a polar aprotic or protic solvent, or a solvent mixture. Suitable solvents are dimethyl-formamide, dimethylacetamide, dimethyl sulfoxide, N-methyl-2-pyrrolidone, water, ethanol, methanol, propanol. The matrix (M) may be added here to the particles (PA), or else the particles (PA) may be added to the matrix (M). For dispersing the particles (PA) in the matrix material (M) it is possible to use further additives and adjuvants that are typically employed for dispersion. These include Brönsted acids, such as hydrochloric acid, phosphoric acid, sulfuric acid, nitric acid, trifluoroacetic acid, acetic acid, methyl-sulfonic acid, for example, Brönsted bases, such as triethylamine and ethyldiisopropylamine, for example. As further adjuvants it is possible, moreover, to use all commonly used emulsifiers and/or protective colloids. Examples of protective colloids are polyvinyl alcohols, cellulose derivatives or vinylpyrrolidone polymers. Customary emulsifiers are, for example, ethoxylated alcohols and phenols (alkyl radical: C₄-C₁₈, EO degree: 3-100), alkali metal salts and ammonium salts of alkyl sulfates (C₃-C₁₈), sulfuric and also phosphoric esters, and alkylsulfonates.

Particular preference is given to sulfosuccinic esters and also alkali metal alkyl sulfates and also polyvinyl alcohols. Two or more protective colloids and/or emulsifiers can also be used, as a mixture.

Where particles (PA) and matrix (M) are present in solid form, the dispersions (D) may also be prepared by a melt or extrusion process.

Alternatively the dispersion (D) can be prepared by modifying particles (P) in the matrix material (M). For that purpose the particles (P) are dispersed in the matrix material (M) and then reacted with the oligomers (A) to give the particles (PA).

Where the dispersions (D) contain aqueous or organic solvents, the corresponding solvents are removed after the dispersion (D) has been prepared. The removal of the solvent in this case is accomplished preferably by distillation. Alternatively the solvent may remain in the dispersion (D) and be removed by drying in the course of the production of the composite material (K).

The dispersions (D) may, moreover, retain common solvents and also the adjuvants and additives typical in formulations. Such would include, among others, flow control assistants, surface-active substances, adhesion promoters, light stabilizers such as UV absorbers and/or free-radical scavengers, thixotropic agents, and also further solids and fillers. To generate the particular profiles of properties that are desired in each case, both of the dispersions (D) and of the composites (K), adjuvants of this kind are preferred.

For producing the composite materials (K), the dispersions (D) comprising particles (PA) and matrix (M) are knife-coated onto a substrate. Other methods are dipping, spraying, casting, and extrusion processes. Suitable substrates include glass, metal, wood, silicon wafers, and plastics such as poly-carbonate, polyethylene, polypropylene, polystyrene, and PTFE, for example.

Where the dispersions (D) are mixtures of particles (PA) and reactive resins (M), the dispersions are cured preferably following the addition of a curing agent or initiator, by means of actinic radiation or thermal energy.

Alternatively the composite materials (K) can be produced by forming the particles (PA) of the invention in the matrix (M). One common process for producing these composite materials (K) is the sol-gel synthesis, in which particle precursors, such as hydrolysable organometallic compounds or organosilicon compounds, for example, and also the oligomers (A), are dissolved in the matrix (M) and subsequently the particle formation process is initiated, by addition of a catalyst, for example. Suitable particle precursors in this case are tetraethoxysilane, tetramethoxysilane, methyltrimethoxysilane, phenyltrimethoxysilane, etc. To produce the composites (K), the sol-gel mixtures are applied to a substrate and dried by evaporation of the solvent.

In a likewise preferred method a cured polymer is swollen by a suitable solvent and immersed into a solution which comprises, as particle precursors, for example, hydrolysable organometallic or organosilicon compounds, and also the oligomers (A). Particle formation from the particle precursors accumulated in the polymer matrix is then initiated subsequently by means of the methods identified above.

On account of their outstanding chemical, thermal, and mechanical properties, the composite materials (K) may be used in particular as adhesives and sealants, as coatings, and also as sealing compounds and casting compounds.

In a further embodiment of the invention the particles (PA) of the invention are characterized in that they have a high thickening action in polar systems, such as solvent-free polymers and resins, or solutions, suspensions, emulsions, and dispersions of organic resins, in aqueous systems or in organic solvents (e.g.: polyesters, vinyl esters, epoxides, poly-urethanes, alkyd resins, etc.), and hence are suitable rheological additives in these systems.

As a rheological additive in these systems, the particles (PA) supply the required viscosity, structural viscosity, and thixotropy that are needed, and provide a yield point which is sufficient for the capacity to stay on vertical surfaces.

In a further embodiment of the invention the surface-modified particles (PA) are characterized in that in powder systems they prevent instances of caking or agglomeration, under the influence of moisture, for example, but also have no tendency toward reagglomeration, and hence toward unwanted separation, but instead keep powders fluid and hence allow robust, storage-stable mixtures. Generally speaking, particle quantities of 0.1% to 3% by weight are used, based on the powder system. This applies in particular to use in nonmagnetic or magnetic toners and developers and charge control assistants, such as in contactless or electrophotographic printing/reproduction processes, which may be one-component and two-component systems. This is also the case in resins in powder form that are used as paint systems.

The invention further provides for the use of the particles (PA) in toners, developers, and charge control assistants. Examples of such developers and toners are magnetic one-component and two-component toners, and also nonmagnetic toners. As their main constituent these toners may comprise resins, such as styrenic and acrylic resins, and may preferably be ground to particle distributions of 1-100 μm, or may be resins which have been prepared in polymerization processes in dispersion or emulsion or solution or in bulk with particle distributions of preferably 1-100 μm. Silicon oxide and metal oxide is used with preference to enhance and control the powder flow properties, and/or to regulate and control the triboelectric charging properties of the toner or developer. Toners and developers of this kind can be used in electrophotographic printing and impression processes, and can also be employed in direct image transfer processes.

All of the above symbols in the above formulae have their definitions in each case independently of one another. In all of the formulae the silicon atom is tetravalent.

Unless indicated otherwise, all quantitative and percentage figures are based on the weight, all pressures are 0.10 MPa (abs.), and all temperatures are 20° C.

### EXAMPLE 1

### Synthesis of an Oligomer A, Inventive

A mixture of 48 mmol of methacryloyloxymethyltriethoxysilane (GENIOSIL® XL-36, Wacker Chemie AG, Munich, Germany), 0.6 mmol of Cu(I) Cl and 1.32 mmol of 2,2′-bipyridine in 10 ml of toluene is admixed under a nitrogen atmosphere with 1.8 mmol of ethoxybromoisobutyrate. The mixture is heated to 70° C. over a period of 12 h. It is filtered through a coarse sieve (100 mesh) to give a 56% solution of oligomethacrylosilane in toluene, having—as determined by GPC—a number-average molar mass of 4280 g/mol and a weight-average molar mass of 6670 g/mol, for a polydispersity of 1.55. The conversion rate as determined via ¹H NMR is 85%.

### EXAMPLE 2

### Synthesis of an Oligomer A, Inventive

A mixture of 48 mmol of methacryloyloxymethyl(di-ethoxy)methylsilane (GENIOSIL® XL-34, Wacker Chemie AG, Munich, Germany), 0.6 mmol of Cu(I)Cl and 1.32 mmol of 2,2′-bipyridine in 10 ml of toluene is admixed under a nitrogen atmosphere with 1.8 mmol of ethoxybromoiso-butyrate. The mixture is heated to 70° C. over a period of 12 h. It is filtered through a coarse sieve (100 mesh) to give a 52% solution of oligomethacrylosilane in toluene, having—as determined by GPC—a number-average molar mass of 3860 g/mol and a weight-average molar mass of 6030 g/mol, for a polydispersity of 1.57. The conversion rate as determined via ¹H NMR is 75%.

### EXAMPLE 3

### Synthesis of an Oligomer A, Inventive

A mixture of 48 mmol of methacryloyloxypropyltrimethoxysilane (GENIOSIL® GF-31, Wacker Chemie AG, Munich, Germany), 0.6 mmol of Cu(I)Cl and 1.32 mmol of 2,2′-bipyridine in 10 ml of toluene is admixed under a nitrogen atmosphere with 1.8 mmol of ethoxybromoiso-butyrate. The mixture is heated to 70° C. over a period of 12 h. It is filtered through a coarse sieve (100 mesh) to give a 45% solution of oligomethacrylosilane in toluene, having—as determined by GPC—a number-average molar mass of 5672 g/mol and a weight-average molar mass of 10 200 g/mol, for a polydispersity of 1.81. The conversion rate as determined via ¹H NMR is 70%. The molecular weight distribution indicates a low degree of condensation between individual oligomer molecules.

### EXAMPLE 4

### Synthesis of an Oligomer A, Inventive

A mixture of 48 mmol of methacryloyloxymethyl(di-methoxy)methylsilane (GENIOSIL® XL-32, Wacker Chemie AG, Munich, Germany), 0.6 mmol of Cu(I)Cl and 1.32 mmol of 2,2′-bipyridine in 10 ml of toluene is admixed under a nitrogen atmosphere with 1.8 mmol of ethoxybromoiso-butyrate. The mixture is heated to 70° C. over a period of 12 h. It is filtered through a coarse sieve (100 mesh) to give a 53% solution of oligomethacrylosilane in toluene, having—as determined by GPC—a number-average molar mass of 3730 g/mol and a weight-average molar mass of 6100 g/mol, for a polydispersity of 1.81. The conversion rate as determined via ¹H NMR is 65%.

### EXAMPLE 5

### Synthesis of an Oligomer A, Inventive

A mixture of 48 mmol of methacryloyloxymethyltrimethoxysilane (GENIOSIL® XL-33, Wacker Chemie AG, Munich, Germany), 0.6 mmol of Cu(I)Cl and 1.32 mmol of 2,2′-bipyridine in 10 ml of toluene is admixed under a nitrogen atmosphere with 1.8 mmol of ethoxybromoiso-butyrate. The mixture is heated to 70° C. over a period of 15 h. It is filtered through a coarse sieve (100 mesh) to give a 56% solution of oligomethacrylosilane in toluene, having—as determined by GPC—a number-average molar mass of 4730 g/mol and a weight-average molar mass of 8160 g/mol, for a polydispersity of 1.72. The conversion rate as determined via ¹H NMR is >95%.

### EXAMPLE 6

### Synthesis of an Oligomer A, Inventive

A mixture of 96 mmol of methacryloyloxypropyltrimethoxysilane (GENIOSIL® GF-31, Wacker Chemie AG, Munich, Germany), 1.2 mmol of Cu(I)Cl and 2.62 mmol of 2,2′-bipyridine in 20 ml of toluene is admixed under a nitrogen atmosphere with 7.2 mmol of ethoxybromoiso-butyrate. The mixture is heated to 70° C. over a period of 15 h. It is filtered through a coarse sieve (100 mesh) to give a 51% solution of oligomethacrylosilane in toluene, having—as determined by GPC—a number-average molar mass of 5000 g/mol and a weight-average molar mass of 7610 g/mol, for a polydispersity of 1.52. The conversion rate as determined via ¹H NMR is >95%.

### EXAMPLE 7

### Synthesis of an Oligomer A, Inventive

A mixture of 10 mmol of hydroxypropyl methacrylate, 96 mmol of methacryloyloxypropyltrimethoxysilane (GENIOSIL® GF-31, Wacker Chemie AG, Munich, Germany), 1.2 mmol of Cu(I)Cl and 2.62 mmol of 2,2′-bipyridine in 20 ml of toluene is admixed under a nitrogen atmosphere with 7.2 mmol of ethoxybromoisobutyrate. The mixture is heated to 70° C. over a period of 15 h. It is filtered through a coarse sieve (100 mesh) to give a 58% solution of hydroxypropyl-modified oligomethacrylosilane in toluene, having—as determined by GPC—a number-average molar mass of 4636 g/mol and a weight-average molar mass of 7600 g/mol, for a polydispersity of 1.64. The conversion rate as determined via ¹H NMR is >80%.

### EXAMPLE 8

### Synthesis of an Oligomer A, Inventive

A mixture of 10 mmol of butyl methacrylate, 96 mmol of methacryloyloxymethyltrimethoxysilane (GENIOSIL® XL-33, Wacker Chemie AG, Munich, Germany), 1.2 mmol of Cu(I)Cl and 2.62 mmol of 2,2′-bipyridine in 20 ml of toluene is admixed under a nitrogen atmosphere with 7.2 mmol of ethoxybromoisobutyrate. The mixture is heated to 70° C. over a period of 15 h. It is filtered through a coarse sieve (100 mesh) to give a 53% solution of butyl-modified oligomethacrylosilane in toluene, having—as determined by GPC—a number-average molar mass of 4820 g/mol and a weight-average molar mass of 7220 g/mol, for a polydispersity of 1.50. The conversion rate as determined via ¹H NMR is >95%.

### EXAMPLE 9

### Synthesis of an Oligomer A, Inventive

A mixture of 10 g mmol of methacryloyloxymethyltrimethoxysilane (GENIOSIL® XL-33, Wacker Chemie AG, Munich, Germany), 0.3 g mmol of lauryl mercaptan and 0.3 g of tert-butyl peroxybenzoate in 20 ml of toluene is heated to 110° C. over a period of 7 h under a nitrogen atmosphere. This gives a 33% solution of oligomethacrylosilane in toluene.

### EXAMPLE 10

### Synthesis of an Oligomer A, Inventive

A mixture of 10 grams of methacryloyloxypropyltrimethoxysilane (GENIOSIL® GF-31, Wacker Chemie AG, Munich, Germany), 0.3 gram of lauryl mercaptan and 0.3 gram of tert-butyl peroxybenzoate in 20 ml of toluene is heated to 110° C. over a period of 7 h under a nitrogen atmosphere. This gives a 33% solution of oligomethacrylosilane in toluene, having a number-average molar mass as determined by GPC of approximately 7000 g/mol.

### EXAMPLE 11

### Modification of a Particle with Subsequent Solvent Exchange

5.00 g of a silica sol in isopropanol (IPA-ST® from Nissan Chemical; 30.5% by weight SiO₂; average particle size 12 nm) is admixed dropwise with a solution of 150 μl of the 51% solution of the oligomer described in example 6, and the reaction mixture is stirred at room temperature for 12 h. Following addition of 15 g of methoxypropyl acetate, the reaction mixture is concentrated under reduced pressure to a solids content of 10% by weight. This gives a modified silica sol which exhibits a slight Tyndall effect and contains only traces of isopropanol.

### EXAMPLE 12

### Modification of a Particle with Subsequent Solvent Exchange

5.00 g of a silica sol in isopropanol (IPA-ST® from Nissan Chemical; 30.5% by weight SiO₂; average particle size 12 nm) is admixed dropwise with a solution of 75 μl of the 56% solution of the oligomer described in example 5, and the reaction mixture is stirred at room temperature for 12 h. Following addition of 15 g of methoxypropyl acetate, the reaction mixture is concentrated under reduced pressure to a solids content of 10% by weight. This gives a modified silica sol which exhibits a slight Tyndall effect and contains only traces of isopropanol.

### EXAMPLE 13

### Modification of a Particle with Subsequent Isolation and Redispersion

5.00 g of a silica sol in isopropanol (IPA-ST® from Nissan Chemical; 30.5% by weight SiO₂; average particle size 12 nm) is admixed dropwise with a solution of 150 μl of the 51% solution of the oligomer described in example 6, and the reaction mixture is stirred at room temperature for 12 h. Subsequently the solvent is evaporated and the resulting precipitate is redispersed in isopropanol. This gives a transparent dispersion which like the unmodified silica sol exhibits a slight Tyndall effect.

### EXAMPLE 14

### Production of Coating Formulations, and of the Coatings Obtainable therefrom, and Characterization of the Coatings

For the preparation of a coating formulation, an acrylate-based paint polyol having a solids content of 52.4% by weight (solvents: solvent naphtha, methoxy-propyl acetate (10:1)), a hydroxyl group content of 1.46 mmol/g resin solution, and an acid number of 10-15 mg KOH/g is mixed with Desmodur® BL 3175 SN from Bayer (butane oxime-blocked polyisocyanate, blocked NCO content of 2.64 mmol/g). The amounts of the respective components that are employed are apparent from table 1. Subsequently the amounts indicated in table 1 of the dispersions prepared in accordance with synthesis examples 10 or 11 are added. In each of these cases, molar ratios of protected isocyanate functions to hydroxyl groups of approximately 1.1:1 are attained. Furthermore, 0.01 g of a dibutyltin dilaurate and 0.03 g of a 10% strength solution of ADDID® 100 from TEGO AG (flow control assistant based on polydimethyl-siloxane) in isopropanol are admixed, to give coating formulations having a solids content of approximately 50%. These mixtures, which initially are still slightly turbid, are stirred at room temperature for 48 h, giving clear coating formulations.

TABLE 1
Formulas of the varnishes

| | Polyacrylic | Desmodur ® | | Particle |
|---|---|---|---|---|
| | polyol | BL 3175 SN | Nanosol of | content* |
| Varnish 1 | 4.0 g | 2.43 g | none | 0% |
| (not inventive) | | | | |
| Varnish 2 | 4.0 g | 2.43 g | Example 12 | 2.55% |
| | | | (1.0 g) | |
| Varnish 3 | 4.0 g | 2.43 g | Example 11 | 2.55% |
| | | | (1.0 g) | |

*Fraction of the particles as a proportion of the overall solids content of the respective varnish formulation

The coating materials with the compositions indicated in table 1 are each applied using a coating knife with a slot height of 120 μm, and a Coatmaster® 509 MC film-drawing apparatus from Erichsen, to a glass plate. The coating films obtained are then dried in a forced-air drying cabinet at 70° C. for 30 minutes and then at 150° C. for 30 min. All of the varnish formulations produce visually flawless, smooth coatings.

The gloss of the coatings is determined using a Microgloss 20° gloss meter from Byk, and for all of the varnish formulations the gloss is between 159 and 164 gloss units. The scratch resistance of the cured varnish films thus produced is determined using a Peter-Dahn abrasion tester. For this purpose a Scotch Brite® 2297 scouring pad with a surface area of 45×45 mm is loaded with a weight of 500 g. Using this scouring pad, the varnish specimens are scratched with a total of 50 strokes. Both before the beginning and after the end of the scratch tests, the gloss of the respective coating is measured with a Byk Microgloss 20° gloss meter.

The parameter determined as a measure of the scratch resistance of the respective coating is the loss of gloss in comparison to the initial value:

TABLE 2
Loss of gloss in the Peter-Dahn scratch test

| Varnish sample | Loss of gloss |
|---|---|
| Varnish 1 | 82% |
| (not inventive) | |
| Varnish 2 | 43% |
| Varnish 3 | 50% |

The results show the distinct improvement in the composites through the addition of suitably modified particles.

1.-7. (canceled)

8. A composition comprising alkoxysilyl-functional oligomers (A) and their hydrolysis and condensation products, the oligomers obtained by polymerization of 100 parts by weight of ethylenically unsaturated alkoxy-functional silane(s) together with 0 to 100 parts by weight of ethylenically unsaturated comonomers.

9. An alkoxysilyl-functional oligomer of claim 8, wherein the silanes are compounds of the formula [1]
R¹ₙ(R¹¹O)₃₋ₙSi-L-O—CO—CR²¹═CH₂ [1]
where
R¹, R¹¹, and R²¹ each individually are C₁-C₈ alkyl radicals,
n is 0, 1 or 2, and
L is a C₁-C₈ alkylene radical.

10. Core-shell particles which on their surface carry oligomer (A) of claim 8 or a hydrolysis or condensation product thereof.

11. A process for producing particles which on their surface carry oligomer (A) or a hydrolysis or condensation product thereof, comprising reacting particles with an oligomer (A) of claim 8 or a hydrolysis or condensation product thereof.

12. The process of claim 11, wherein particles which have functions selected from metal-OH, metal-O-metal, Si—OH, Si—O—Si, Si—O-metal, Si—X, metal-X, metal-OR², Si—OR² are reacted with oligomers (A) or their hydrolysis, alcoholysis, and condensation products,
where
R² is a substituted or unsubstituted alkyl radical and
X is a halogen atom.

13. A process for producing the core-shell particles of claim 10, comprising attaching an oligomer to particles during the synthesis of the particles.

14. A composite material comprising an organic or inorganic polymer as a matrix, and core-shell particles of claim 10.
